(19) United States
(12) Patent Application Publication
(10) Pub. No.: US 2006/0104551 A1
(43) Pub. Date: May 18, 2006

(54) Linear movement guide and method for its manufacture

(75) Inventors: Hans-Martin Schneeberger, Langenthal (CH); Ernst Mischler, Roggwil (CH); Aldo Schaller, Biberist (CH)

Correspondence Address: VENABLE LLP, P.O. BOX 34385, WASHINGTON, DC, 20045-9998, US

(73) Assignee: Schneeberger Holding AG, Roggwil (CH)

(21) Appl. No.: 11/215,127

(22) Filed: Aug. 31, 2005

(30) Foreign Application Priority Data
Sep. 3, 2004 (EP) 04405549.9

(51) Int. Cl. F16C 17/00

(52) U.S. Cl. 384/26

(57) ABSTRACT

In order to keep to a minimum the expense, in particular, the expense for the formation of reference surfaces, with a linear guide system with two guide rails (10, 12) and, respectively, two carriages (30, 32), it is proposed that a spacing plate (20) is welded, adhered, or is attached in another manner, such that the reference marks of the guide rails (10, 12) can further form the reference for the system. As a further feature, it is proposed to weld, adhere, etc., a further spacing plate (60) between the carriages (30, 32).

### TECHNICAL FIELD OF THE INVENTION

The invention relates to a linear movement guide with at least two guide rails and at least one carriage supported on the respective guide rails and moveable along a longitudinal movement axis of the guide. In addition, the present invention relates to a method for making a linear movement guide.

### BACKGROUND OF THE INVENTION

In a very commonly known linear movement guide, a carriage is supported via a roller element arranged in at least one rotary unit on the guide rail. The carriage is moved on the rail along a longitudinal movement axis based on a rotation of the roller body in the rotary unit. The invention, however, includes not only such linear roller bearing guides, but also, for example, guides in which the carriages are supported via plain bearings, fluid bearings, or magnetic bearings on the rail.

Linear movement guides are used generally for translatory, in particular, straight-line movement and guiding of machine parts, such as is required, for example, with the movement of translatory axes of a tooling machine. Although the linear guides often are used in a very dirty environment and in unfavorable conditions, for example, in high temperatures, a high precision is required of them. A requirement for enabling a high precision of the movement of the machine parts is the securing of a large rigidity of the guide. The guide, based on loads, therefore should not displace or deform if possible. Likewise, the natural frequency of the machine parts, which are provided on a support and the linear movement guide attached thereon, should lie as high as possible in an innocuous range with small oscillation amplitude. A further essential requirement for a precise movement of the machine parts is that the roller element of the carriage is not soiled, since this has a disadvantageous effect on the wear and the guiding accuracy.

The guide rails, for the most secure and rigid attachment as possible, are provided on a support generally with through-bores running orthogonally to its surface, which are provided for receiving attachment elements, such as, for example, screws.

In a specialized application of such a linear movement guide, two rails are provided next to one another, which have a fixed distance from one another and on which, then, respectively, two carriages can be placed, in order to form a linear movement system. According to EP-A-1 080 829, for example, it is proposed to provide contact edges on the guide rails, to attach aligned guide rails on plates, etc, to place the carriages on the guide rails, and to use specific surfaces of the guide rails and the carriages as alignment surfaces of the entire system. Such an embodiment according to the prior art is shown in FIGS. 1 and 2, in which the guide rails 101 and 102 are screwed onto a plate 104. The upper plate 106 is then screwed on the carriages 110 and 112. A linear motor 114 serves to drive the linear movement system. According to the prior art cited here, it is possible in this embodiment to use stop faces of the guide rails as adjustment surfaces and not, for example, the lower plate 104.

It was determined, however, that this assembly requires a high manufacturing expense and produces therewith manufacturing redundancies. The original stop faces are mounted namely on the guide rails; the support surfaces, however, are on the lower assembly, so that, here, a quasi-two-stage reference system is necessary.

### OBJECT OF THE INVENTION

The invention, therefore, is based on the object of producing a linear movement guide of this type and proposing a method for its manufacture, so that the manufacturing expense is reduced, without having to reduce the requirements on the adjustability of the entire system.

### SUMMARY OF THE INVENTION

This object is solved with a linear movement guide of the initially described type with at least two guide rails and at least one carriage, respectively, supported on each of the guide rails and moveable along a longitudinal movement axis of the guide, in which the guide rails are provided for arrangement on a support by means of attachment means, wherein—between the at least two guide rails, a lower spacing plate is welded, adhered, or fixedly disposed in another manner, whereby the lower spacing plate, in relation to the guide rails. The features of the present invention first have the result that stop faces on both guide rails further represent adjustment surfaces for the entire system. In a preferred embodiment of the invention, also the surfaces of the carriages represent upper adjustment surfaces. The accuracy of the linear movement guide is ensured in a preferred embodiment by high-precision welding with the aid of gauges. In a likewise proposed, alternative embodiment of the present invention, it is provided that the connection—preferably, likewise, with a gauge—is provided by adhesion. The accuracy of the assembly, however, is permitted by stop faces on the guide rails or the carriages, and must not be removed by corresponding surfaces to the spacing plates.

According to a second aspect of the invention, the invention also includes a method for making a linear movement guide with at least two guide rails and at least one carriage, respectively, supported on each of the guide rails and moveable along the longitudinal movement axis of the guide, in which the guide rails are provided for arrangement on a support by means of attachment means, wherein between the at least two guide rails a lower spacing plate is welded, adhered, or is fixedly disposed in another manner, which determine, in relation to the guide rails, their spacing.

Further preferred forms of the present invention are provided in the dependent claims. These preferred embodiments include further developments of the present invention, without departing from the fundamental idea of the invention.

The exemplary embodiments described above, as well as the embodiments claimed and the elements used in the present invention to be described subsequently are not subject to any particular exceptions with regard to their dimensions, structure, material use, and technical conception, so that the selection criteria known in the respective application can find unlimited use.

Further details, features, and advantages of the subject matter of the present invention are provided from the subsequent description of the accompanying drawings, in which, by way of example, a device and an associated method for the present invention are explained.

The invention is described based on a linear movement system, in which the spacing plates are first welded, adhered, or connected in an equivalent manner between the guide rails. It should be clear to the practitioner or it is noted here that the invention can be carried out not only in one manner, that the spacing plates can be arranged between the guide rails also as well as between the carriages, whereby any combination of the connection method is included, but also where such spacing plates are arranged only between the carriages. For such subject matter, patent applications can be filed based on this application.

In addition, it should be clear to the practitioner or it is noted here that for the present invention in the description provided herein, the process of welding, on the one hand, is meant to be very concrete. However, on the other hand, this process substitutes for other, basically exchangeable manufacturing processes.

### BRIEF DISCUSSION OF THE FIGURES

In the figures:

FIG. 1 shows a plan view on a linear guide system having two guide rails and two carriages, according to the prior art;

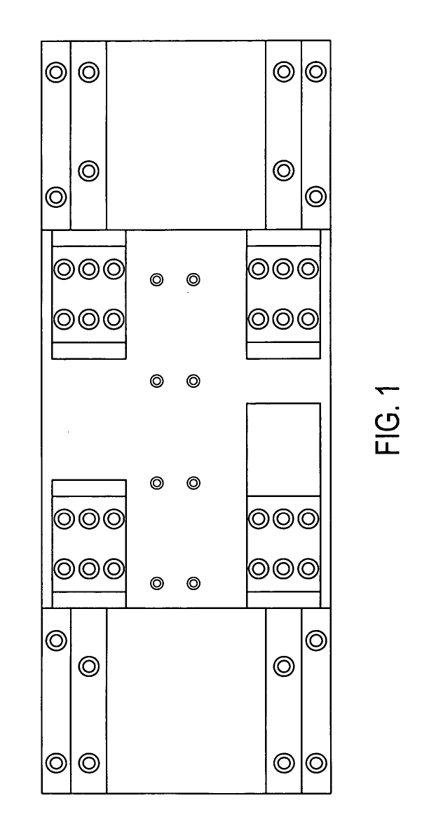

FIG. 2 shows a side view of the linear guide system having two guide rails and two carriages according to the prior art and FIG. 1;

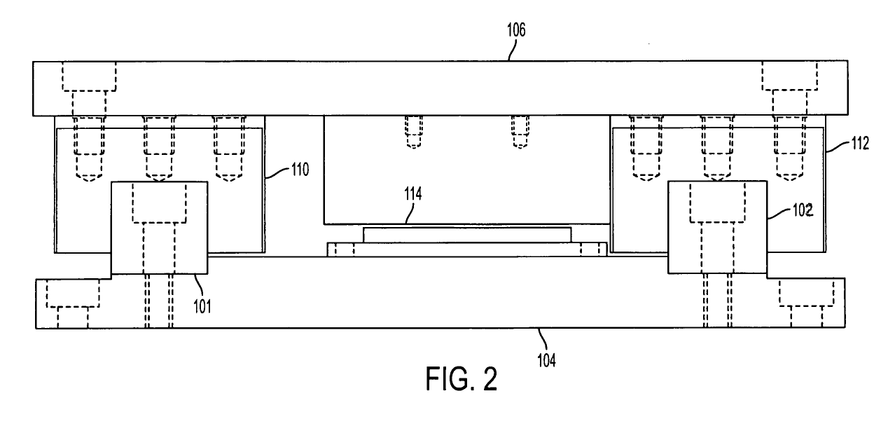

FIG. 3 shows a plan view of a linear guide system having two guide rails and two carriages according to a first embodiment of the present invention;

FIG. 4 shows a side view of the linear guide system having two guide rails and two carriages according to the embodiment of the present invention shown in FIG. 3;

FIG. 5 shows a perspective view of the linear guide system having two guide rails and two carriages according to the embodiment of the present invention shown in FIG. 3;

FIG. 6 shows a plan view of a linear guide system having two guide rails and two carriages according to a second embodiment of the present invention; and

FIG. 7 shows a side view of the linear guide system having two guide rails and two carriages according to a further embodiment of the present invention.

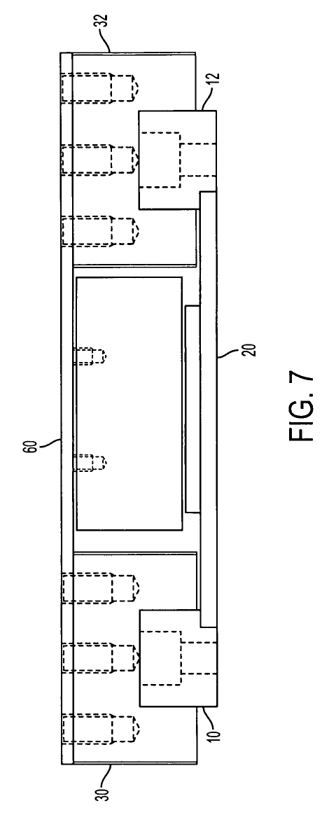

### DETAILED DESCRIPTION OF THE PREFERRED EMBODIMENTS

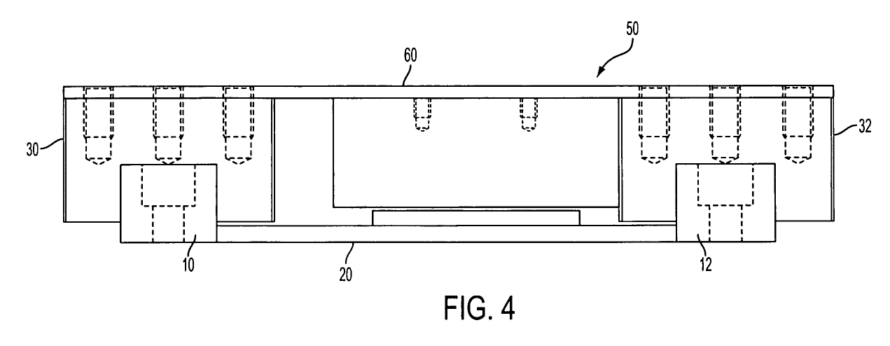

In the linear movement device designated as a whole in FIG. 4 with reference numeral 50, two guide rails 10 and 12 of the above-described type are provided. Between these guide rails, a spacing plate 20 is welded. The welding process is carried out in the present exemplary embodiment, such that the welding is performed with the aid of a welding gauge, in which two guide rails are mounted for definition of a predetermined spacing. The lower spacing plate 20 is welded, then, by laser welding. The welding is performed as a linear welding, respectively, over sections of approximately 20 to 50 mm. Such a welding seam is carried out from both sides, that is, above and below. It was shown specifically that an individual welding seam—that is, only above or only below—did not lead to the necessary stability. It is particularly advantageous and therefore is also carried out in the embodiment described herein, that the lower spacing plate is chamfered before welding on the top side. In this manner, the welding seam can be sunken practically into the chamfer of the plate. Likewise, the guide rails, respectively, are chamfered on the side facing the lower spacing plate, whereby, then, the lower welding seam likewise can be sunken. In order to obtain further for the guide rails the property of maintaining a lower side of the linear movement system, the lower side of the lower spacing plate, upon welding, is disposed, such that it remains above the lower side of the guide rails.

So that four carriages 30 and 32 are placed on the guide rails 10 and 12, the carriages 30 and 32 are arrested with a further gauge and then, in a second step, an upper spacing plate 60 is welded by laser welding. Also, this welding is performed as a linear welding, respectively, over one section. The linear welding is carried out, again, from both sides of the welding seam, respectively, between the guide rails and the upper spacing plate. In the present exemplary embodiment, also the upper spacing plate is chamfered before welding on the side. Also the outer edges of the carriages, respectively, are chamfered on the side facing the upper spacing plate. In order also to obtain for the carriages the property of forming a top side of the linear movement system, also the top side of the upper spacing plate, upon welding, is disposed, such that it remains, after welding, beneath the top sides of the carriages.

In the previously described exemplary embodiment, the drive mechanism as a linear drive is applied on both spacing plates 20 and 60. Alternatively, however, the drive also can be formed in a manner known already for such linear drives.

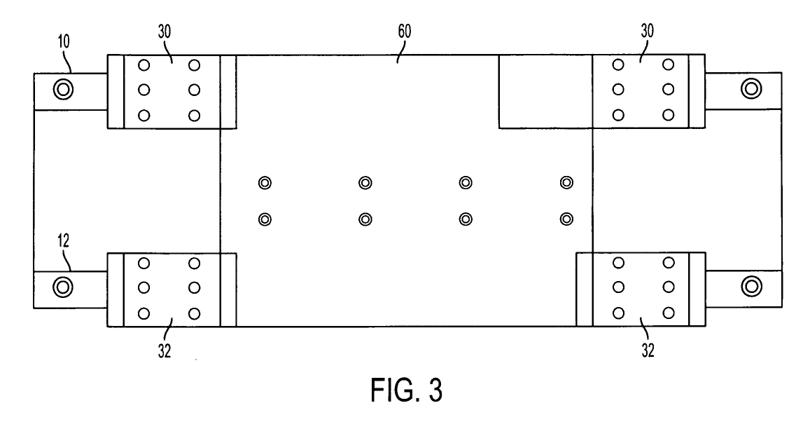

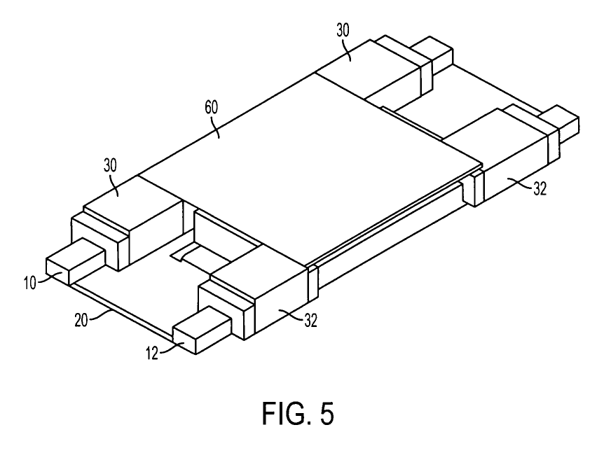

In the linear movement system shown in FIGS. 3 through 5, the upper spacing plate is formed to be approximately rectangular. Originating at its corners, two welding seams are applied on the front side of two carriages and two welding seams are applied on the back side of two further carriages. In this embodiment, the upper spacing plate, then, is arranged between the carriages.

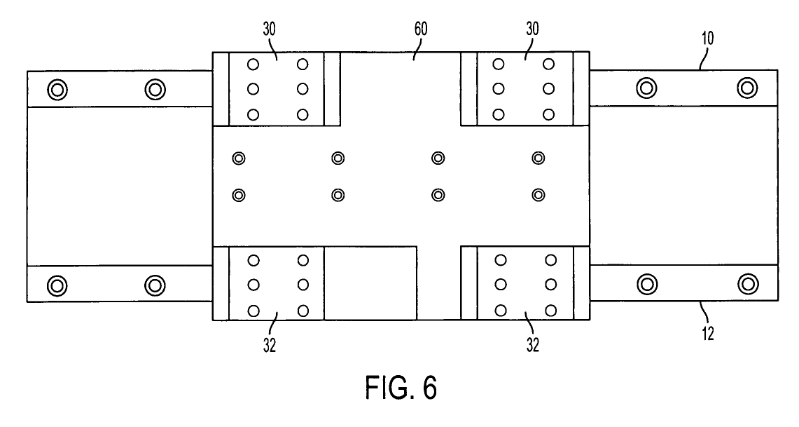

In an alternative embodiment according to FIG. 6, the upper spacing plate is formed to be approximately rectangular with four rectangular cut-outs on its corners. The carriages, then, are welded on the positions of the cut-outs. This has the property that the welding seams can be formed longer overall, which can lead to a greater solidity.

In a further embodiment of the invention, the lower spacing plate is not welded, but adhered. Since it is advantageous with the existing proportions have a specific adhesion surface, in this case, the guide rails are provided with a cut-out or a groove on the inner, lower sides. It is evident for the practitioner that this embodiment with a groove or a cut-out—in all cases, also in combination with the chamfers according to the above description—also can be used with the first described embodiment with the welded spacing plates.

1. Linear movement guide with at least two guide rails and at least one carriage, respectively, supported on each of the guide rails and moveable along a longitudinal movement axis of the guide, in which the guide rails are provided for arrangement on a support by means of attachment means, wherein—between the at least two guide rails, a lower spacing plate is welded, adhered, or fixedly disposed in another manner, whereby the lower spacing plate, in relation to the guide rails, determines their spacing.

2. Linear movement guide according to claim 1, wherein the lower spacing plate is welded and at least one welding seam of the lower spacing plate is disposed in a chamfer of the lower spacing plate.

3. Linear movement guide according to claim 2, wherein in that at least one welding seam of the lower spacing plate is disposed in a chamfer of the guide rails.

4. Linear movement guide according claim 2, wherein the lower side of the lower spacing plate, after the welding, remains above the lower side of the guide rails.

5. Linear movement guide according to claim 1, wherein the lower spacing plate is adhered, whereby the guide rails, respectively, have a groove, in which or on which the lower spacing plate is adhered, respectively.

6. Linear movement guide according to claim 1, wherein between the carriages, an upper spacing plate is welded, whereby the upper spacing plate, in relation to the carriages, determine their spacing.

7. Linear movement guide according to claim 6, wherein the upper spacing plate is welded and at least one welding seam of the upper spacing plate is disposed in a chamfer of the upper spacing plate.

8. Linear movement guide according to claim 7, wherein at least one welding seam of the upper spacing plate is disposed in a chamfer of the carriages.

9. Linear movement guide according to claim 7, wherein the upper side of the upper spacing plate, after welding, remains beneath the upper sides of the carriages.

10. Linear movement guide according to claim 7, wherein the upper spacing plate is formed to be approximately rectangular and that it is welded to the front side of two carriages and on the back side of two further carriages starting at its corners.

11. Linear movement guide according to claim 7, wherein the upper spacing plate is formed to be approximately rectangular with four rectangular cut-outs at its corners and the carriages are welded to the positions of the cut-outs.

12. Linear movement guide according to claim 6, wherein the upper spacing plate is adhered, whereby the carriages each have a groove or a cut-out, in which or on which the upper spacing plate, respectively, is adhered.

13. Method for making a linear movement guide with at least two guide rails and at least one carriage, respectively, supported on each of the guide rails and moveable along the longitudinal movement axis of the guide, in which the guide rails are provided for arrangement on a support by means of attachment means, wherein between the at least two guide rails a lower spacing plate is welded, adhered, or is fixedly disposed in another manner, which determine, in relation to the guide rails, their spacing.

14. Method for making a linear movement guide according to claim 13, wherein welding by means of a welding gauge is performed, in which two guide rails, for definition of a predetermined spacing, are mounted, and that the lower spacing plate is welded by laser welding.

15. Method according to claim 14, wherein the welding is performed in a first step as a linear welding, respectively, over one section, whereby the linear welding is performed from both sides of the welding seam, respectively, between the guide rails and the lower spacing plate.

16. Method according to claim 14, wherein the lower spacing place is chamfered before the welding at least on the top side.

17. Method according to claim 14, wherein the guide rails, respectively, are chamfered at least on the side facing toward the lower spacing plate.

18. Method according to claim 14, wherein the lower side of the lower spacing plate is arranged upon welding, such that it remains after welding above the lower side of the guide rails.

19. Method according to claim 13, wherein the lower spacing plate is adhered, whereby the guide rails, respectively, have a groove or a cut-out, in which or on which the lower spacing plate, respectively, is adhered.

20. Method for making a linear movement guide according to claim 13, wherein in a second step, an upper spacing plate is welded, adhered, or fixedly disposed in another manner between the carriages, wherein the upper spacing plate, in relation to the carriages, determines their distance.

21. Method according to claim 20, wherein in the second step, a welding is performed by means of a welding gauge, in which at least two carriages are mounted for definition of a predetermined spacing and that the upper spacing plate is welded by means of laser welding.

22. Method according to claim 21, wherein the welding in the second step is performed as a linear welding, respectively, over one section, wherein the linear welding of both sides of the welding seam is performed, respectively, between the carriages and the upper spacing plate.

23. Method according to claim 21, wherein the upper spacing plate is chamfered at least on the side before the welding.

24. Method according to claim 21, wherein the top side of the upper spacing plate upon welding is disposed, such that it remains after the welding beneath the top sides of the carriages.

25. Method according to claim 21, wherein the upper spacing plate is formed to be approximately rectangular and that, beginning from its corners, two welding seams are applied on the front side of two carriages and two welding seams are applied on the back side of two further carriages.

26. Method according to claim 21, wherein the upper spacing plate is formed to be approximately rectangular with four rectangular cut-outs at its corners and the carriages are welded on the positions of the cut-outs.
